(19) United States
(12) Patent Application Publication
(10) Pub. No.: US 2009/0265358 A1
(43) Pub. Date: Oct. 22, 2009

(54) Methods, Systems, And Computer Program Products For Accessing Metadata Associated With A Network-Accessible Resource

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/107,263

(22) Filed: Apr. 22, 2008

(51) Int. Cl. G06F 17/30

(52) U.S. Cl. 707/10; 707/E17.032

(57) ABSTRACT

Methods and systems are described for accessing metadata associated with a network-accessible resource. a resource message including access information for accessing a network-accessible resource is received. The resource message may be received in response to a request to access the resource or may be received asynchronously. Metadata subscription information for establishing a subscription for metadata associated with the resource is received with the resource message. A subscription to the metadata is established based on the metadata subscription information. The metadata associated with the resource is received pursuant to the subscription. The metadata that is received is presented before, during, or after a representation of the network-accessible resource is presented.

In another aspect, an indication for providing access a network-accessible resource is received. Responsive to receiving the indication, metadata subscription information is provided for establishing a subscription for metadata associated with the resource. Responsive to receiving the indication, access to the network-accessible resource is provided.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

Many resources are accessible via the web, whether the resources are accessible through the Internet and through an intranet of an entity. Some resources are relatively permanent and some resources are short-lived. For example, most transactions are short-lived. Generally, all resources have some form of metadata associated with them that is not readily accessible through access of the resource. In particular, a resource's presence tuple (typically consisting of a status of the resource, a communication address of the resource, and other optional objects about the resource) is not accessible via a browser request to access the resource. There is no standard mechanism for accessing this metadata.

### SUMMARY

Methods and systems are described for accessing metadata associated with a network-accessible resource. In one aspect, a resource message including access information for accessing a network-accessible resource is received. The resource message may be received in response to a request to access the resource or may be received asynchronously. Metadata subscription information for establishing a subscription for metadata associated with the resource is received with the resource message. A subscription to the metadata is established based on the metadata subscription information. The metadata associated with the resource is received pursuant to the subscription. The metadata that is received is presented before, during, or after a representation of the network-accessible resource is presented.

In another aspect, an indication for providing access a network-accessible resource is received. Responsive to receiving the indication, metadata subscription information is provided for establishing a subscription for metadata associated with the resource. Responsive to receiving the indication, access to the network-accessible resource is provided.

### BRIEF DESCRIPTION OF THE DRAWINGS

Advantages of the claimed invention will become apparent to those skilled in the art upon reading this description in conjunction with the accompanying drawings, in which like reference numerals have been used to designate like or analogous elements, and in which:

FIG. 1 is a flow diagram illustrating a method for accessing metadata associated with a network-accessible resource according to an aspect of the subject matter described herein;

FIG. 2 is block a diagram illustrating a system for accessing metadata associated with a network-accessible resource according to another aspect of the subject matter described herein;

FIG. 3A is a block diagram illustrating an exemplary execution environment in which the system of FIG. 2 may operate;

FIG. 3B is a block diagram illustrating another exemplary environment in which the system of FIG. 2 may operate and in which an instant messaging client can request and receive access to a network accessible resource in accordance with an aspect of the subject matter described herein;

FIG. 4 is a block diagram illustrating a client node communicating with a resource provider node and a subscription service node via a network;

FIG. 5 is a flow diagram illustrating a method for providing access to metadata associated with a network-accessible resource according to another aspect of the subject matter described herein;

FIG. 6 is a block diagram illustrating a system for providing access to metadata associated with a network-accessible resource according to another aspect of the subject matter described herein;

FIG. 7A is a block diagram illustrating an execution environment in which the system of FIG. 6 operates in an HTTP server application

FIG. 7B is a block diagram illustrating an alternate execution environment in which the system of FIG. 6 operates in a presence service application; and

FIG. 8 is an illustration of a resource being tracked on a map.

### DETAILED DESCRIPTION

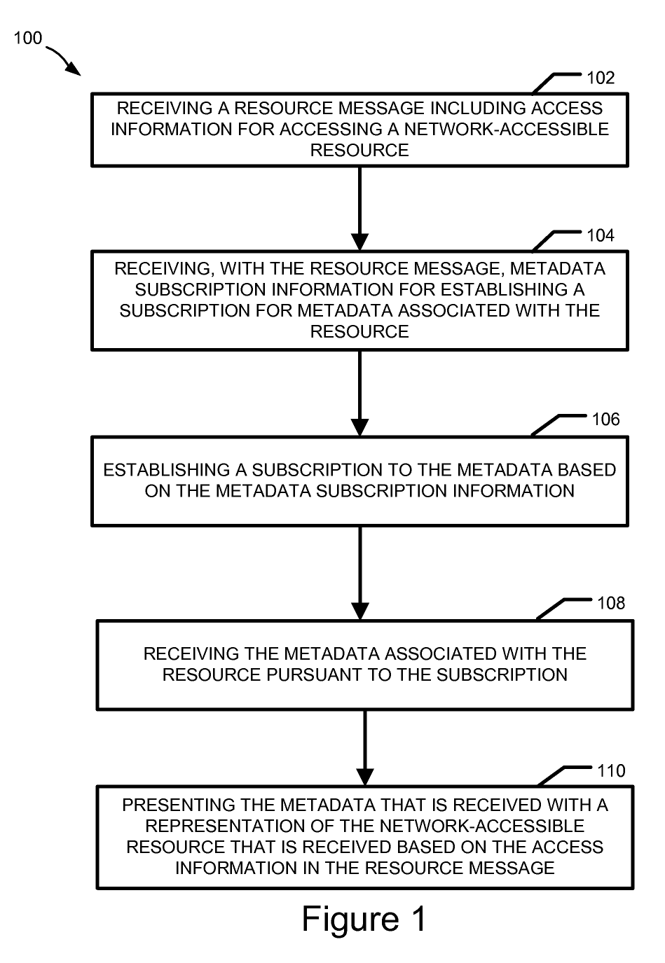

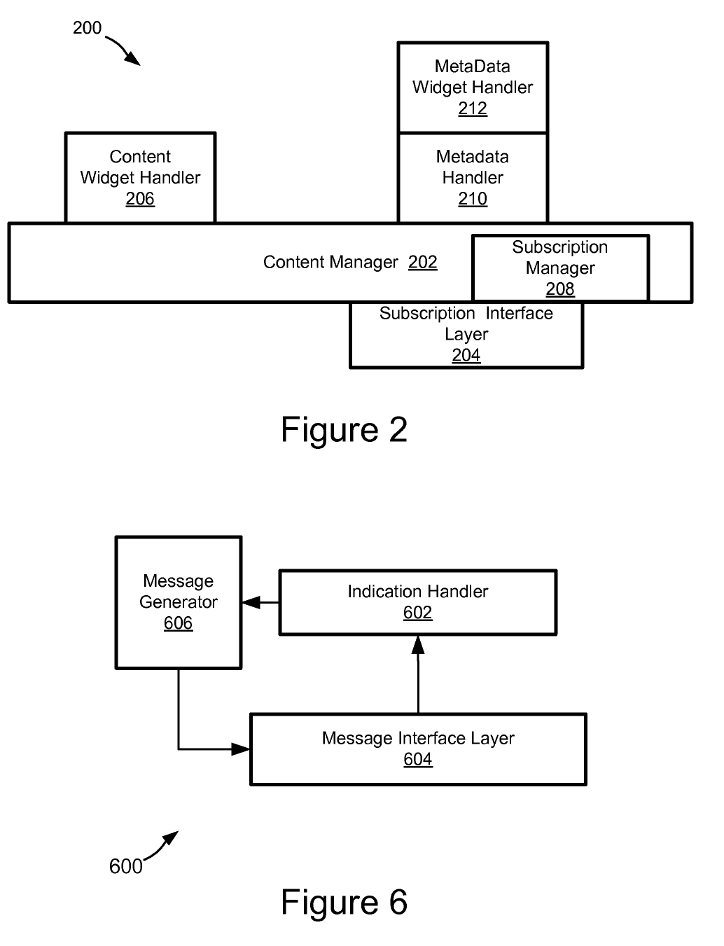

FIG. 1 is a flow diagram illustrating a method for accessing metadata associated with a network-accessible resource according to an exemplary aspect of the subject matter described herein. FIG. 2 is a block diagram illustrating a system for accessing metadata associated with a network-accessible resource according to another exemplary aspect of the subject matter described herein. The method illustrated in FIG. 1 can be carried out by, for example, some or all of the components illustrated in the exemplary system of FIG. 2.

With reference to FIG. 1, in block 102, a resource message including access information for accessing a network-accessible resource is received. Access to the network-accessible resource includes the ability to perform creating, deleting, reading, and writing operations. Accordingly, a system for accessing metadata associated with a network-accessible resource includes means for receiving a resource message including access information for accessing a network-accessible resource. For example, as illustrated in FIG. 2, a content manager component 202 is configured for receiving a resource message including accessing information for accessing a network-accessible resource. Note that the network-accessible resource may be a service. In another aspect, the resource message is received by a browser.

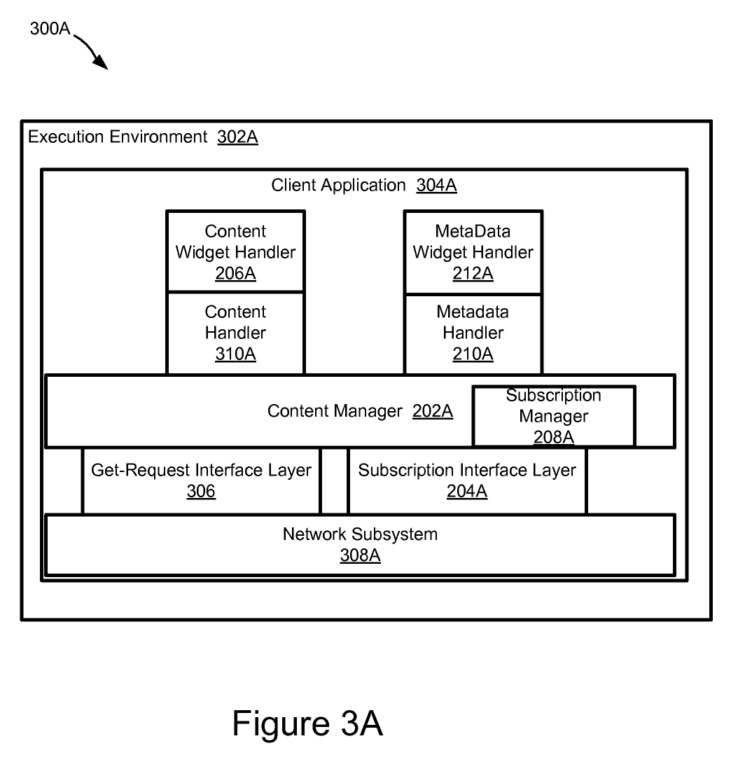

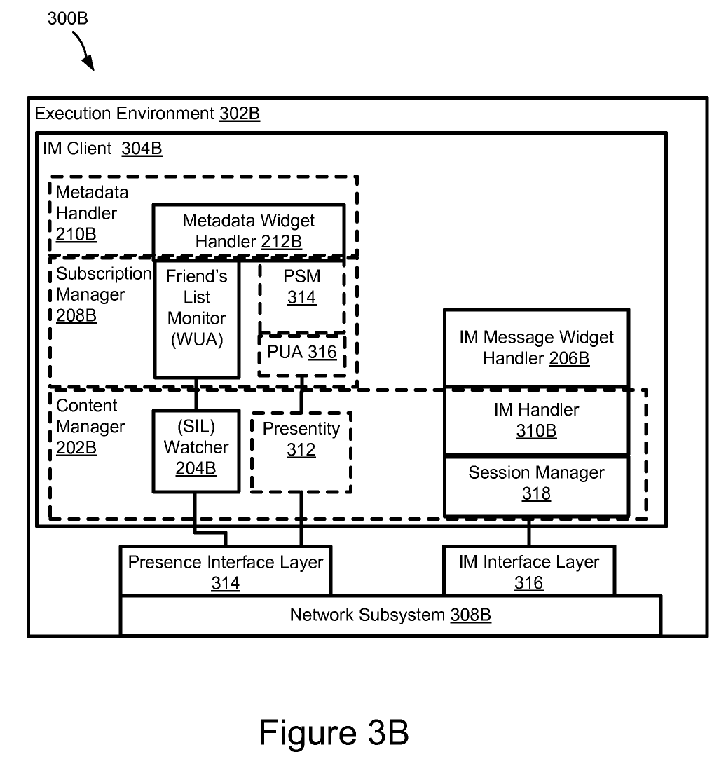

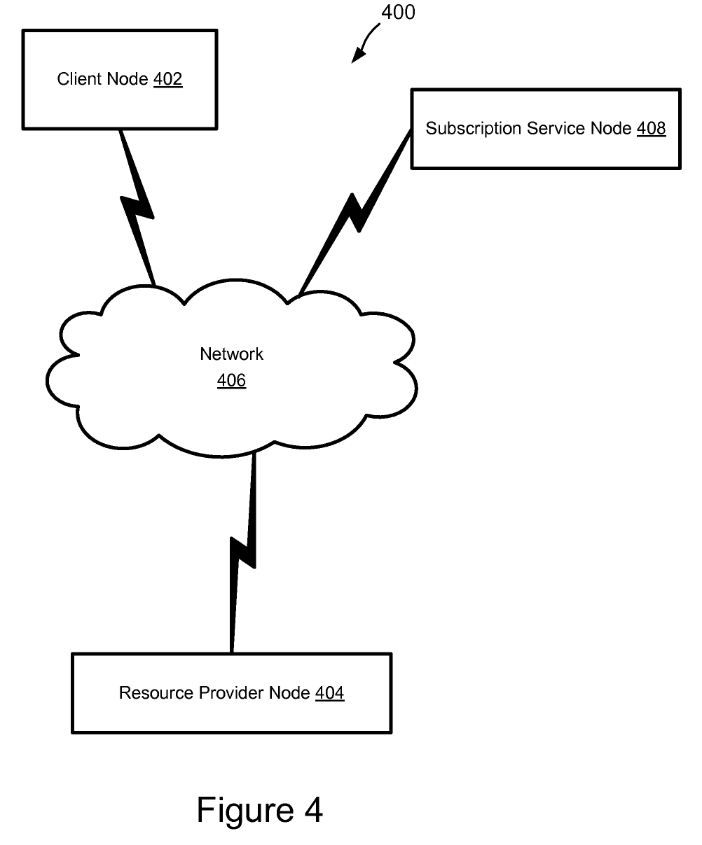

Turning to FIG. 2 in conjunction with FIGS. 3a, 3b, and 4, the content manager component 202 is shown in various alternatives 202A 202B operating in exemplary execution environments 302A, 302B of a client node 402 along with the other components shown in FIG. 2 that are described herein below.

The content manager component 302A included in client application 304A is configured to use one or more protocols for communicating with a resource provider hosted by a resource provider node 404 via a network 406. The content manager component 202 is configured to interoperate with a protocol layer compatible with a protocol supported by the resource provider. For example, a get-request interface layer 306 in FIG. 3a and a subscription interface layer 204, 204A, 204B in FIG. 2 and in FIGS. 3a and 3b are configured to interoperate with the content manager component 202, 202A, 202B for transmitting a resource request to access a resource. The resource message can be received in response to the resource request. In another aspect, the resource request can include resource subscription information for establishing a subscription for accessing the network-accessible resource. In a further aspect, the resource message can be received as an asynchronous message. The asynchronous resource message can be received by the content manager 202 without being solicited.

The get-request interface layer 306 supports one or more get-request protocols such as HTTP (hypertext transfer protocol), FTP (file transfer protocol, XMPP (extensible messaging and presence protocol), and SIP (session initiation protocol). The subscription interface layer 204 supports any number of subscription protocols including pub-sub and presence protocols according to RFC 2778 & 2779 such as SIP-SIMPLE (SIP for instant messaging and presence leveraging extensions) and XMPP-IM (XMMP: instant messaging and presence), and/or content or topic based pub-sub protocols.

Note that FIG. 3b is a block diagram of an instant messaging client 304B operating with a presence protocol in which the components of FIG. 2 may operate. Well known presence protocols, such as the presence protocol portions of the extensible messaging and presence protocol instant messaging (XMPP-IM), session initiation protocol (SIP) for instant messaging and presence leveraging extensions (SIP SIMPLE), and rendezvous protocol (RVP), are used by presence services, and Jabber Software Foundation's pub/sub protocol as specified in Jabber Enhancement Proposal (XEP) XEP-0060: Publish-Subscribe specifies a general purpose publish-subscribe protocol. The architecture, models, and protocols associated with presence services in general are described in “Request for Comments” (or RFC) documents RFC 2778 to Day et al., titled “A Model for Presence and Instant Messaging” (February 2000), RFC 2779 to Day et al., titled “Instant Messaging/Presence Protocol” (February 2000), and RFC 3921 to Saint-Andre et. al., titled “Extensible Messaging and Presence Protocol (XMPP): Instant Messaging and Presence,” each of which are published and owned by the Internet Society and incorporated here in their entirety by reference.

According to the presence service model described in RFC 2778, two distinct agents of a presence service client are defined. The first of these agents, called a “presentity” (combining the terms “presence” and “entity”), such as presentity 312, provides presence information to be stored and distributed by the presence service on behalf of a presence client such as IM client 304B. The second type of presence agent is referred to as a “watcher.” Watchers such as watcher 204B receive presence information from a presence service on behalf of a presence client. Users of the presence service are referred to in the presence model described in RFC 2778 as principals. Typically, a principal is a person or group, but can also represent software or other resources capable of interacting with the presence service. A principal can interact with the presence system through a presence user agent (PUA) or a watcher user agent (WUA). As in the case of the presentity and watcher clients in whom these service clients interact, the presentity and watcher user agents can be combined functionally as a single user agent having both the characteristics of the presentity and watcher user agents. The principal status monitor (PSM) 314 reports the principal's status via PUA 316 to the presentity for sending to the presence service.

Requests for access are transmitted to a resource provider node 404 via a network subsystem 308A, 308B included in the execution environments 302A, 302B, respectively. The network subsystem 308A, 308B can be operatively coupled to the network 406.

The content manager component 202, 202A, 202B can request access to the resource in response to a received user input processed by a widget handler component such as a content widget handler component 206, 206A (see FIGS. 2, 3A), or an instant message widget handler component 206B (see FIG. 3B). For example, a mouse-click input can be received with a mouse pointer over an active link in a web page presented in a content widget on a display where the content widget is created and managed by the content widget handler component 206, 206A, 206B interoperating with various components of the execution environment 302A, 302B. In one aspect, the content manager component 202 receives access to the resource in response receiving a message that includes access information for accessing the resource. The message may be an unsolicited message.

While current request formats and protocols can be used as they are today in performing the request, current request formats and protocols can be modified to extend the method described and new request formats and protocols can be created. Three examples of such modifications are below.

In the first example, an HTTP Get header has a new content header, which in the example, is labeled “Content-Subscription.” The new content header, which shall be called a content-subscription content header, can be defined for indicating whether a client supports processing subscription information associated with a received resource. The presence of the header can prevent a properly configured resource provider from providing information that can be ignored by the client, or worse, uncover a bug. The exemplary value “TRUE” can be defined to indicate processing subscription information is supported or desired and a value of “FALSE” can indicate non-support or that subscription information should otherwise not be provided.

EXAMPLE 1
HTTP Get w/ Subscription Content Header

GET /TFPS/Catalog/Shoes HTTP/1.1
Host: some.ps.server
User-Agent: Mozilla/5.0 (X11; U; Linux i686; en-US; rv:1.4.1)
Gecko/20031114
Accept: text/html;q=0.9,text/ \plain;q=0.8,video/x-
mng,image/png,image/jpeg,image/gif;q=0.2,*/*;q=0.1
Accept-Language: en-us,en;q=0.5
Accept-Encoding: gzip,deflate
Accept-Charset: ISO-8859-1,utf-8;q=0.7,*;q=0.7
Content-Subscription: TRUE

### EXAMPLE 1

### HTTP Get w/Subscription Content Header

Additional information can be provided, such as a tuple id identifying a tuple to which the metadata should be published and to which the sender of the “Get” can subscribe. Alternatively, a port number and/or a network address can be provided indicating a communication endpoint for receiving subscription information on the client or for identifying a communication endpoint to be called for retrieving subscription information. A synchronous protocol can be supported where the receiver of the subscription information requests the information and receives it in a response and/or an asynchronous protocol can be used allowing the subscription information to be sent without a preceding and corresponding request.

In the second example, an exemplary instant message is formatted according to the CPIM (common profile for instant messaging) format specified in RFC 3862. Since CPIM supports content headers, the techniques described with respect to the HTTP Get command are applicable to subscription information associated with an instant message and/or a resource identified in an instant message. Example 2 below includes separate content-subscription headers indicating that subscription information can be processed and further identifies specific resources (e.g., san.jose@weather.com) for which subscription information is desired and associated with resources in the message received by a recipient of the instant message.

m: Content-type: Message/CPIM
s:
h: From: TOM <im:tsmothers@example.com>
h: To: DICK <im:dsmothers@example.com>
h: DateTime: 2000-12-13T13:40:00-08:00
h: Subject: the weather will be fine today
s:
e: Content-type: text/xml; charset=utf-8
e: Content-ID: 1234567890@foo.com
e: Content-Subscription: TRUE:san.jose@weather.com
e: Content-Subscription: TRUE:tsmothers@example.com
e:
e: <body>
e: The weather is nicer than it is at your place.
e: </body>

### EXAMPLE 2

### IM Message in CPIM Format

In the third example, an exemplary instant message is formatted according to the XMPP-IM format specified in RFC 3921. While XMPP-IM does not support content headers, a XML element can be defined that provides an analogous way to provide a “content header.” Example 3 includes an <metadata-subscription> element for indicating whether subscription information can be processed and/or is desired by the sender of the message that can be viewed as a request for a reply. The single element <metadata-subscription/> can be defined as equivalent to <metadata-subscription> YES</metadata-subscription>. The value “YES” can be defined to indicate the sender is capable of and/or desires subscription information. In other words, the request can include an indicator that subscription information is supported and/or desired.

```
<?xml version=“1.0” encoding=“UTF-8”?>
<message>
  <id>0x4fc5f</id>
  <metadata-subscription/>
  <from>DICK</from>
  <datetime>2006-03-25T08:24:50-05:00</datetime>
  <subject>Re: <metaMom</subject>
  <body>She liked you best.</body>
</message>
```

### EXAMPLE 3

### IM Message

Returning to FIG. 1, in block 104 subscription information for establishing a subscription for metadata associated with the resource is received with the resource message. A system for accessing metadata associated with a network-accessible resource also includes means for receiving, with the resource message, subscription information for establishing a subscription for metadata associated with the resource. For example, as illustrated in FIG. 2, a subscription manager component 208 is configured for receiving, with the resource message, subscription information for establishing a subscription for metadata associated with the resource.

The resource provider node 404 can send a message including resource information via the network 406 to the client node 402. The message is received by the subscription manager component 208 of content manager component 202 via the network subsystem 308A, 308B and optionally via a protocol supported by the get-request interface layer 306 and/or the subscription interface layer 204.

The message can be a synchronous response to a request message, such as an HTTP response sent by the resource provider node 404 in response to an HTTP GET or POST message sent by the client node 402 as described above. Alternatively, the subscription information can be received in an asynchronous message either unsolicited or in response to a subscription request message sent from the client node 402 to the resource provider node 404 supporting a subscription protocol such as a pub-sub protocol. The subscription information can be included in a notification message sent as a result of a subscription request sent to a subscription service node 408 such as a presence service.

As indicated, the subscription information can be received in a resource message including resource information. Alternatively, in alternative message flow patterns, the subscription information can be received in a metadata access information message separate from the resource message including the resource information.

Examples of an alternative flow pattern are briefly described in Table 1.

| Pattern | Description |
|---|---|
| 1 | A resource message including resource information is received in a |
| | response to a request for a resource or service. The resource message |
| | can include metadata subscription information along with the resource |
| | information. |
| 2 | A resource Request for a resource is followed by a Response in the form |
| | of a resource message that includes the resource information. The |
| | resource Request and Response have a corresponding metadata |
| | Request for metadata subscription information followed by a response in |
| | the form of a metadata message including metadata subscription |
| | information. The metadata subscription information request-response |
| | messages can be transmitted and/or received before, during, and/or after |
| | the resource request and response messages are transmitted and/or |
| | received. |
| 3 | A resource Request for a resource is followed by a Response to the |
| | request including the resource information and a corresponding |
| | asynchronous metadata message is sent to the requestor including |
| | metadata subscription information. The asynchronous metadata |
| | message can be sent in response to a resource provider receiving the |
| | request for the resource. |
| 4 | The resource request message is a resource subscription request and |
| | the response message is one or more notifications including the resource |
| | information (e.g., tuple information associated with a tuple identified in the |
| | subscription request). Patterns 1-3 are all applicable for receiving the |
| | metadata subscription information since a resource subscription request |
| | followed by one or more notifications can be considered a type of |
| | resource request-response message pattern. |
| 5 | The resource subscription information request-response described in |
| | pattern 2 and one of the variations of pattern 4 can be a resource |
| | subscription request for resource subscription information and the |
| | response can be one or more resource notify messages where each |
| | resource notify message is received with metadata subscription |
| | information based on one or more of the previously described patterns. |
| 6 | An unsolicited resource message can be sent to the client including |
| | resource information. One or more of the patterns 1-3 with respect to |
| | corresponding receiving subscription information with the resource |
| | message can be supported. |

In another aspect, the metadata subscription information is received in message, such as a resource message or a metadata message, in a header, a trailer, and/or a payload of the response. Example 4 shown below depicts an HTTP Post header with a new content header labeled in the example as “Content-Subscription-Ref”. The content-subscription-ref content header can be defined for informing the receiver of the Post command that subscription information is available for at least a portion of the content included in the HTTP message. Note that example 4 conforms to the pattern described in item 6 above. Note further that the “client” from the perspective of the subscription information is an HTTP service and/or application communicating via an HTTP service.

POST /TFPS/Catalog/Shoes HTTP/1.1
Host: some.ps.server
User-Agent: Mozilla/5.0 (X11; U; Linux i686; en-US; rv:1.4.1)
Gecko/20031114
Accept: text/html;q=0.9,text/\plain;q=0.8,video/x-
mng,image/png,image/jpeg,image/gif;q=0.2,*/*;q=0.1
Accept-Language: en-us,en;q=0.5
Accept-Encoding: gzip,deflate
Accept-Charset: ISO-8859-1 ,utf-8;q=0.7,*;q=0.7
Content-Subscription-Ref: xmpp:me@myserver.com/data/thisContent
Content ...

### EXAMPLE 4

### HTTP Post with Subscription Information

The content-subscription-ref header can be included in the HTTP header or in a header of a content portion of the message payload associated with all or a portion of the content in the message payload as illustrated in Example 5. In example 4, the content-subscription-ref in the message header provides subscription information for the content in the payload. An index or subscription identifier or other form of a subscription indicator can be associated with a portion of subscription information for identifying a corresponding portion of the content in the payload with which the subscription information portion is associated (not shown).

POST /TFPS/Catalog/Shoes HTTP/1.1
Date: Wed, 08 Sep 2004 17:33:31 GMT
Server: Apache/1.3.27 (Unix) (Red-Hat/Linux) PHP/4.1.2
Last-Modified: Wed, 08 Sep 2004 17:02:40 GMT
Content-Length: 8942
Subscription: duration=533s,id=5
Content-Type: multi-part/mixed
.
.
.
@-----------------------------------------------------------
Content-Subscription-Ref: xmpp:some@ps.server/TFPS/Catalog/Shoes
.
.

### EXAMPLE 5

### HTTP Post with Subscription Information

Example 6, which is analogous to Examples 4 and 5 above, uses a new MIME type, “principal/xmpp”, that is defined for specifying subscription information as payload content rather than including the subscription information in a content header.

POST /TFPS/Catalog/Shoes HTTP/1.1
Date: Wed, 08 Sep 2004 17:33:31 GMT
Server: Apache/1.3.27 (Unix) (Red-Hat/Linux) PHP/4.1.2
Last-Modified: Wed, 08 Sep 2004 17:02:40 GMT
Content-Length: 8942
Subscription: duration=533s,id=5
Content-Type: multi-part/mixed
.
.
.
@-----------------------------------------------------------
Content-Type: principal/xmpp
some@ps.server/TFPS/Catalog/Shoes
.
.
.

### EXAMPLE 6

### HTTP Post with Subscription Information

Example 7 illustrates a response to an HTTP Get or Post request that includes subscription information in a content-subscription-ref header and the resource included in the message payload (not shown).

HTTP/1.1 200 OK
Date: Wed, 08 Sep 2004 17:32:31 GMT
Server: Apache/1.3.27 (Unix) (Red-Hat/Linux) PHP/4.1.2
Last-Modified: Wed, 08 Sep 2004 17:02:40 GMT
Content-Length: 9119
Subscription: duration=593s,id=5
Content-Type: text/html
Content-Subscription-Ref:some@ps.server/TFPS/catalog/shoes
.
.
.

### EXAMPLE 7

### HTTP response with Subscription Information

Example 8 below illustrates an XMPP <iq> response, also known as a result, to an <iq> request message. The <iq> request can include a presence protocol publish, subscribe, or notify command. Alternatively, the <iq> request can include an instant message or any protocol using <iq> request and result messages as a transport protocol. In the <iq> result message shown in Example 8, subscription information is provided in an exemplary metadata-id attribute of an <iq> element. Note that the metadata-id attribute can be supported in an <iq> request message as well as in the <iq> result in Example 8.

<iq type=″result″ from=″bigpublishser.com″
to=″tsmothers@example.com″
id=″inbox″ session=”41045″ metadata-
Id=”moredata@md.example.com”/>

### EXAMPLE 8

### XMPP <iq> Response Message

Example 9 below illustrates an FTP URL with a scheme modifier providing subscription information as a URL for establishing a subscription. The “ps” represents any protocol supporting a subscription style interface and extends beyond publish-subscribe protocols. Scheme modifiers are described in U.S. patent application Ser. No. 11/615,438, hereby incorporated by reference in its entirety.

ftp:meta-loc=“ps://pubsub.example.com/myfile”://ftp.example.com/myfile

### EXAMPLE 9

### Scheme Modifier

Example 10 below illustrates HTML resource information that is received that includes an element attribute “metadata-id” that can be defined to accept an identifier such as a URL (uniform resource locator) as subscription information for establishing a subscription for metadata associated with the HTML element in which it is included and/or the element's content. Note that a new HTML or other XML tag can be defined for the same purpose. This technique is applicable for any markup-based language. Non-markup based content can have a format defined for including subscription information as illustrated above with respect to various message and protocol formats.

```
<!doctype HTML PUBLIC “-//W3C//DTD HTML 4.01//EN”
  “http://www.w3.org/TR/htmlX/strict.dtd”>
<html>
  <head>
    <title>My first HTML document</TITLE>
  </head>
  <body metadata-id=“RSS feed identifier”>
    <p>Hello world!</p>
  </body>
</html>
```

### EXAMPLE 10

### HTML with Markup for Subscription

Those skilled in the art will see that the techniques described herein and analogous variations can be used for providing and receiving subscription information for establishing a subscription for metadata associated with a resource for protocols and resource formats including SMTP (simple mail transfer protocol), SMS (short message service), MMS (multimedia messaging service), RSS (really simple syndication), and/or SOAP (simple object access protocol). While each of the examples described above is in the context of a particular protocol or content type, those skilled in the art will see that the techniques are not protocol or type specific.

Regardless of the message flow pattern, the subscription information is received with the resource message. The content manager component 202, 202A, 202B can route the resource information based on, for example, its type, as indicated by a MIME type, to one or more content handler components 310A, 310B configured for processing resource information of the detected MIME type or types. The subscription information can be provided to a subscription manager component 208, 208A, 208B by the content manager component 202, 202A, 202B and/or a content handler component 310A, 310B. In FIG. 3B, the content handler 310B is depicted as instant message (IM) handler configured for processing instant message (IM) content transmitted via an instant message protocol supported by IM interface layer 316. Session manager 318 can be included in IM clients that support message sessions.

The subscription manager component 208, 208A, 208B receives the subscription information for establishing a subscription for data identified by the subscription information as metadata associated with the resource. The subscription manager component 208, 208A, 208B is depicted as a component of the content manager component 202, 202A in FIG. 2 and FIG. 3a and as an external component, subscription manager 208B, to the content manager 202B as depicted in FIG. 3b. In an alternate embodiment, the subscription information can be assigned a MIME type as illustrated above and routed by the content manager component 202, 202A, 202B to the subscription manager component that is provided as a subscription content handler component (not shown). A subscription content handler can be included in a metadata handler 210, 210A, 210B and/or can be a component external to a metadata handler.

Returning to FIG. 1, in block 106 establishing a subscription to the metadata based on the metadata subscription information. Accordingly, a system for accessing metadata associated with a network-accessible resource includes means for establishing a subscription to the metadata based on the metadata subscription information. For example, as illustrated in FIG. 2, a subscription interface layer (SIL) component 204, 204A, 204B, is configured for establishing a subscription to the metadata based on the metadata subscription information. In an aspect of the system in FIG. 3B, the subscription interface layer can be considered to include a presence interface layer 314 for sending and receiving messages from and to the watcher 204B formatted according to a presence protocol.

In another aspect, establishing the subscription includes sending a subscribe message to a subscription service. The subscription manager component 208, 208A, 208B can be configured to request the subscription interface layer 204, 204A, 204B to send a message to a subscription service node 408 via the network 406 to establish a subscription to the metadata. Note that the subscription service may be hosted in a different execution environment from a resource provider execution environment. The subscription information can identify any type or a number of types of subscription data including a pub-sub tuple such as a presence tuple, an RSS feed, a topic maintained by a topic based publish-subscribe service, etc.

The subscription interface layer 204, 204A, 204B establishes the subscription by transmitting the subscription request based on the metadata subscription information over the network 406 via the network subsystem 308A, 308B to the subscription service node 408. Exemplary message flow patterns, protocols, and content have been previously described herein above.

Returning to FIG. 1, in block 108 the metadata associated with the resource is received pursuant to the subscription. The metadata can be received via polling, notification, and/or subsequent responses associated with the network-accessible resource. Accordingly, a system for accessing metadata associated with a network-accessible resource includes means for receiving the metadata associated with the resource pursuant to the subscription. For example, as illustrated in FIG. 2, a metadata handler component 210 is configured for receiving the metadata associated with the resource pursuant to the subscription.

Metadata is sent from the subscription service node 408 over the network 406 to the client node 402 as a metadata message. The metadata message is received by the network subsystem 308A, 308B and provided to a communication endpoint identified to the network subsystem 308. The endpoint identifier can be a communication endpoint established by a protocol supported by the get-request interface layer 306, such as a port for receiving HTTP based RSS messages with metadata. Alternatively, the endpoint identifier can be a communication endpoint established by a protocol of the subscription interface layer 204, 204A, 204B such as a port for receiving XMPP-IM presence notifications or an endpoint for receiving notifications included in a SIP message.

The metadata message is received at metadata handler component 210, 210A, 210B. The message can be received via the content manager component 202, 202A, 202B. The metadata is associated with the resource. The association can be indicated by an identifier of the resource in the metadata or by any other correlation technique. The metadata can be based on a type of message it is received in, a communication endpoint through which it is received and/or sent, a format of the data in the message, and/or an indicator such as a MIME type defined for identifying a specified content type for metadata. The metadata handler component 210A depicted in FIG. 3A can be a content handler component configured for processing metadata formatted according to a recognized MIME type. The MIME type can be defined for metadata content.

Returning to FIG. 1, in block 110 the metadata that is received is presented with a representation of the network-accessible resource that is received based on the access information in the resource message. Accordingly, a system for accessing metadata associated with a network-accessible resource includes means for presenting the metadata that is received with a representation of the network-accessible resource that is received based on the access information in the resource message. For example, as illustrated in FIG. 2, a metadata widget handler component 212 is configured for presenting the metadata that is received with a representation of the network-accessible resource that is received based on the access information in the resource message.

The metadata handler component 210, 210A, 210B processes the metadata and provides the processed data to a metadata widget handler component 212, 212A, 212B for presenting. The metadata can include plain text, markup-based text, executable instructions such as script, audio data, and/or video data and the like. The metadata is presented by the metadata widget handler component 212, 212A, 212B via components present in the execution environment 302A, 302B via a presentation device such as a display, a speaker, and/or device for providing tactile output (not shown).

The metadata is presented typically in correspondence with presentation of the resource. The metadata can be presented by a different application and/or on a different node from the application and node with which the resource is being presented. The metadata can be presented before, during, and/or after the presentation of the resource. At least some of the metadata can be presented automatically, at least some can be presented in response to user input for requesting its presentation, and/or at least some can be presented automatically in response to user input that is contextual. For example, the received metadata can correspond to various portions of the resource or resources being presented. Only metadata corresponding to a resource with focus or with a mouse pointer over is presented, for example.

In one aspect, the subscription information is stored in a stored metadata record that is associated with the network-accessible resource. When the resource is presented, a visual indication associated with the subscription information that is stored can be presented with the along with the resource. The visual indication can be presented at a location on a map. For example, if the metadata includes a location of the network-accessible resource for tracking on a map, the visual indication can be presented on a map that is used to track the resource. One example of using a map is when the resource is portable. The location in the metadata can be associated with a home location of the resource, such as an office of a sales person, and an actual location of the resource, such as the actual location of the sales person in the field. In another aspect, the location is determined by a status notification where status notification includes a geospatial address from a geospatial address space, such as GPS address space.

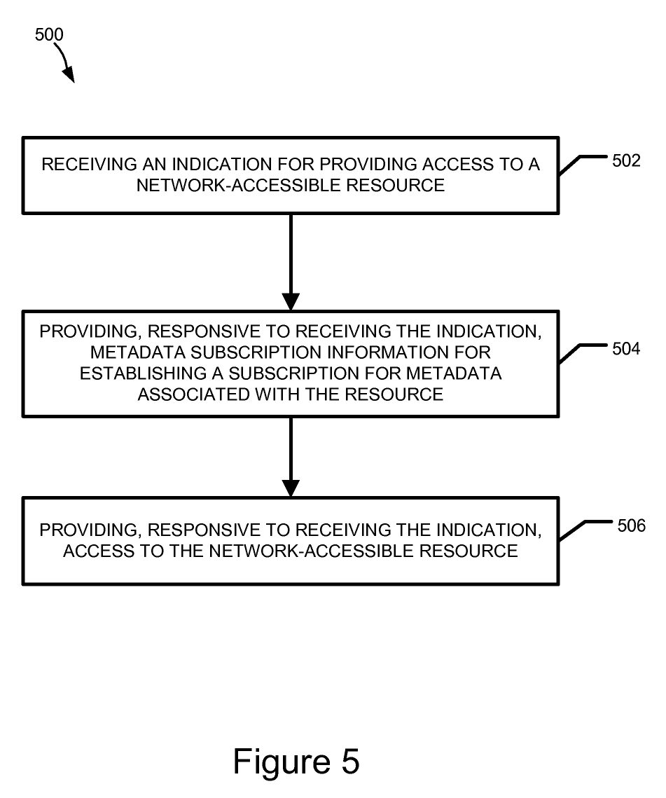

FIG. 5 is a flow diagram illustrating a method for providing access to metadata associated with a network-accessible resource according to an exemplary aspect of the subject matter described herein. FIG. 6 is a block diagram illustrating a system for providing access to metadata associated with a network-accessible resource according to another exemplary aspect of the subject matter described herein. The method illustrated in FIG. 5 can be carried out by, for example, some or all of the components illustrated in the exemplary system of FIG. 6.

With reference to FIG. 5, in block 502 an indication for providing access to a network-accessible resource is received. Accordingly, a system for providing access to metadata associated with a network-accessible resource includes means for receiving an indication for providing access to a network-accessible resource. For example, as illustrated in FIG. 6, an indication handler component 602 is configured for receiving an indication for providing access to a network-accessible resource. The indication may also include a subscription indicator for indicating that metadata subscription information is desired or acceptable. In one aspect, the subscription indication includes a communication endpoint identifier for receiving the metadata subscription information.

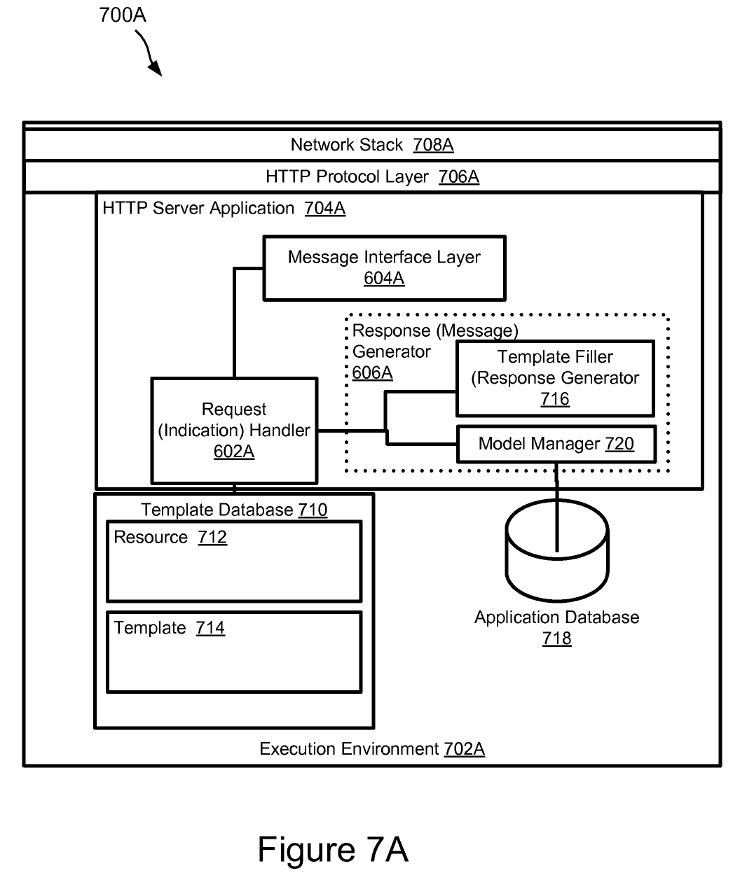

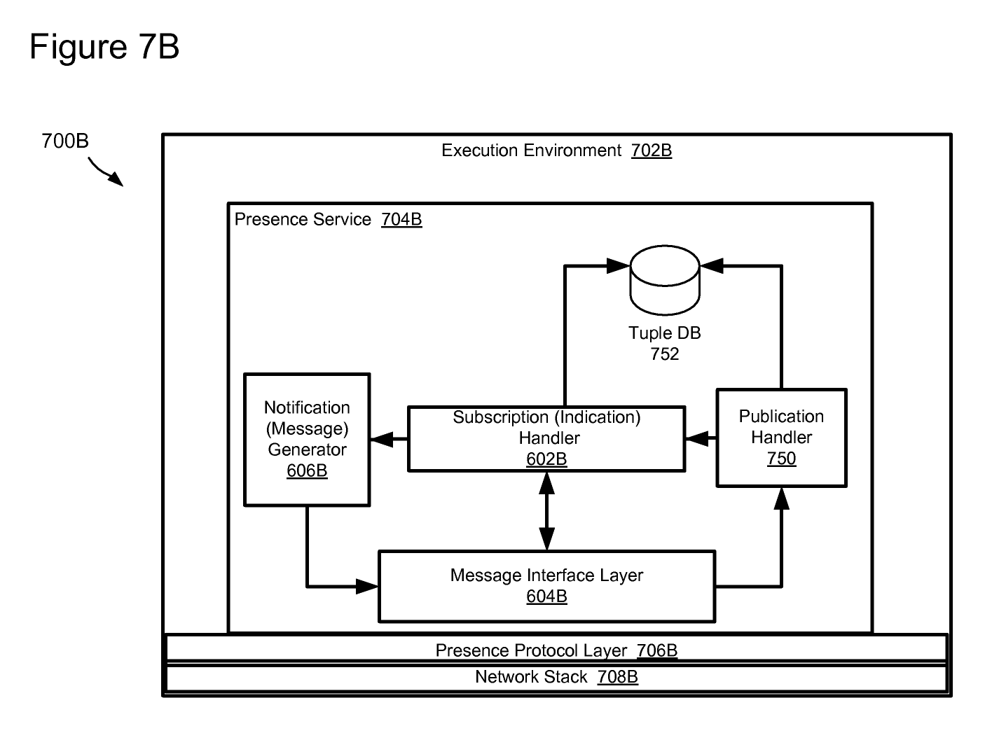

The indication handler component 602 depicted in FIG. 6 is configured for receiving an indication for providing access to a resource. For example, the indication can be a request received as an HTTP command processed by the indication handler component 602A operating as a request handler in the execution environment 702A in an HTTP server application 704A depicted in FIG. 7A. The request handler component 602A receives the message via a message interface layer 604A. The message interface layer 604A can be specific to the application 704A and the execution environment 702A in which the message is received and process.

In the web server application of 704A, a message interface layer 604A is configured for communicating with an HTTP protocol layer 706A. The HTTP protocol layer 706A is configured to communicate with a requesting node, such as the client node 402 over the network 406 via the HTTP protocol. The HTTP protocol layer 706A communicates over the network 406 via a network stack 708A, such as a TCP/IP stack, operatively coupled to the network 406.

FIG. 7B depicts an indication handler component 602B as a subscription handler operating in an execution environment 702B in a presence service application 704B. Analogous to the operation of the components in FIG. 7A, the presence service 704B in FIG. 7B includes a message interface layer 604B configured for communicating with a presence protocol layer 706B. The presence protocol layer 706B is configured to communicate with a subscribing node, such as the client node 402 over the network 406 via a presence protocol such as SIP-Simple and/or XMPP-IM. The presence protocol layer 706B communicates over the network 406 via a network stack 708B, such as a TCP/IP stack, operatively coupled to the network 406.

Returning to FIG. 5, in block 504 responsive to receiving the indication, metadata subscription information is provided for establishing a subscription for metadata associated with the resource. Accordingly, a system for providing access to metadata associated with a network-accessible resource includes means for providing, responsive to receiving the indication, metadata subscription information for establishing a subscription for metadata associated with the resource. For example, as illustrated in FIG. 6, a message generator component handler component 606 is configured for providing, responsive to receiving the indication, metadata subscription information for establishing a subscription for metadata associated with the resource.

The indication handler component 602, 602A, 602B can respond to the received indication as normal based on the type of indication including any protocol used. The indication handler component 602, 602A, 602B can invoke a message generator component 606, 606A, 606B for providing metadata subscription information. The metadata subscription information can be included in a resource message sent as a response to an indication received as a resource request and/or can be sent as a separate metadata message in response to the resource request received. The metadata subscription information can be included in a header, in a trailer, and/or in a payload of the response.

For example, request handler component 602A in FIG. 7A can query a template database 710 for retrieving a pre-generated resource 712 and/or a resource template 714 for generating a resource message as a response for the received resource request. The request handler component 602A invokes a template filler 716 for filling the template using data retrieved from an application database 718 as accessed via a model manager 720.

The template filler 716 and the model manager 720 can be configured to operate as a response generator component 606A for including metadata subscription information in the resource message sent as a response message. Alternatively, they can cooperate for sending the metadata subscription information in a separate metadata message in response to a metadata message request associated with the resource message response or in a metadata message notification sent to the requesting client in association with the resource message.

The subscription handler component 602B in FIG. 7B can establish a subscription based on the received resource subscription request. A publication handler 750 can be included for receiving messages including information for publishing to a database, such as a tuple database 752. A notification generator 606B can be configured to send information published to the database 752 to subscribers such as the requesting client node 402. The published information can be sent in a notification message for example.

The notification generator 606B can be configured to also operate as a message generator component for including metadata subscription information in the notification message for establishing a subscription to metadata associated with the resource information in the resource message notification. Alternatively, the notification generator component 606B can send the metadata subscription information in a separate metadata message notification in response to a second associated metadata subscription request from the client node 402 or in a metadata message notification sent as an unsolicited notification associated with the resource message notification to the requesting client node 402.

Returning to FIG. 5, in block 506 responsive to receiving the indication, access to the network-accessible resource is provided. Accordingly, a system for providing access to metadata associated with a network-accessible resource includes means for providing, responsive to receiving the indication, access to the network-accessible resource. For example, as illustrated in FIG. 6, a message interface layer component 604 is configured for providing, responsive to receiving the indication, access to the network-accessible resource. Along with providing access to the resource, access to metadata associated with the resource is provided.

The message interface layer 604 in FIG. 6 is configured for sending the metadata subscription information provided by the message generator component 606 to the client node 402. In one aspect, the metadata subscription information is provided by the resource provider to an application that can be in the same execution environment as the resource provider or in a different execution environment.

In FIG. 7A, the resource message response including the resource information and the message including the metadata subscription information can be sent to the client node 402 over the network 406 by the message interface layer 604A interoperating with a protocol layer, such as the HTTP protocol layer 706A, also supported by the client node 402. The message(s) is provided to the network 406 for delivery to the client node 402 by the network stack 708A as described above.

In FIG. 7B, the resource message notification including the resource information and the message including the subscription information can be sent to the client node 402 over the network 406 by the message interface layer 604B interoperating with a protocol layer, such as the presence protocol layer 706B, supported by the client node 402. The message(s) is provide to the network 406 for delivery to the client node 402 by the network stack 708B described above.

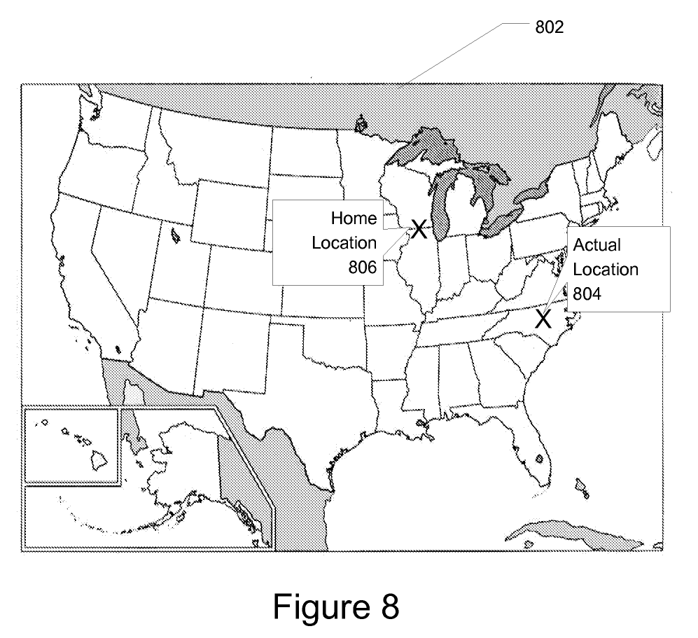

In another aspect, the metadata includes a location of a resource for tracking on a map. The location can be associated with a home location and an actual location. For example, in the map 802 shown in FIG. 8, the resource has an actual location 804 in North Carolina and a home location 806 in Illinois. Note that the network-accessible resource can be a service and the location of the service can be indicated on the map.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, the methods described herein can be embodied in executable instructions stored in a computer readable medium for use by or in connection with an instruction execution machine, system, apparatus, or device, such as a computer-based or processor-containing machine, system, apparatus, or device.

As used here, a “computer readable medium” can include one or more of any suitable media for storing the executable instructions of a computer program in one or more of an electronic, magnetic, optical, electromagnetic and infrared form, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for accessing metadata associated with a network-accessible resource, the method comprising:
receiving a resource message including access information for accessing a network-accessible resource;
receiving, with the resource message, metadata subscription information for establishing a subscription for metadata associated with the resource;
establishing a subscription to the metadata based on the metadata subscription information;
receiving the metadata associated with the resource pursuant to the subscription; and
presenting the metadata that is received with a representation of the network-accessible resource that is received based on the access information in the resource message.

2. The method of claim 1 wherein the resource message is received in response to requesting access to the network accessible resource via a resource request.

3. The method of claim 2 wherein the resource request includes resource subscription information for accessing the network-accessible resource.

4. The method of claim 1 wherein the metadata subscription information is included in at least one of the resource message and a separate metadata access message received in association with the resource message.

5. The method of claim 4 wherein the metadata access message is an asynchronous message.

6. The method of claim 1 wherein receiving the resource message is performed by a browser.

7. The method of claim 1 wherein the network-accessible resource is a service.

8. The method of claim 1 wherein the resource request includes an indicator that subscription information is one of supported or desired.

9. The method of claim 1 wherein receiving the metadata subscription information comprises receiving the metadata subscription information in at least one of a header, trailer, or payload of the resource message.

10. The method of claim 1 wherein the metadata is received from a subscription service hosted in a different execution environment from an execution environment of a service providing access to the resource.

11. The method of claim 1 wherein the metadata is received via at least one of polling, notification, or subsequent responses associated with the network-accessible resource.

12. The method of claim 1 wherein presenting the metadata comprises presenting the metadata at least one of before, during, and after presenting the network-accessible resource.

13. The method of claim 1 wherein presenting the representation of the network-accessible resource is performed by a first application and presenting the metadata comprises presenting the metadata by a second application.

14. The method of claim 1 further comprising storing the subscription information in a metadata record associated with the network-accessible resource.

15. The method of claim 14 wherein presenting the metadata includes providing a visual indication associated with the subscription information that is stored.

16. The method of claim 15 wherein the visual indication is presented at a location on a map.

17. The method of claim 1 wherein the metadata includes a location of the network-accessible resource for tracking on a map.

18. The method of claim 17 wherein the location is associated with a home location and an actual location.

19. The method of claim 17 wherein the location is determined by a status where status values are included in a geoaddress set associated with the map.

20. The method of claim 1 wherein the resource message is an unsolicited message.

21. A method for providing access to metadata associated with a network-accessible resource, the method comprising:
receiving an indication for providing access to a network-accessible resource;
providing, responsive to receiving the indication, metadata subscription information for establishing a subscription for metadata associated with the resource; and
providing, responsive to receiving the indication, access to the network-accessible resource.

22. The method of claim 20 where the indication is included in a resource request for accessing the network-accessible resource.

23. The method of claim 21 wherein the resource request includes a resource subscription for accessing the network-accessible resource.

24. The method of claim 20 wherein the indication includes a communication endpoint identifier of a receiving node for receiving the metadata subscription information.

25. The method of claim 20 wherein providing metadata subscription information comprises sending the metadata subscription information in at least one of a resource message providing access to the network-accessible resource and a metadata message.

26. The method of claim 24 wherein the metadata subscription information is included in at least one of a header, a trailer, or a payload of the resource message.

27. The method of claim 20 wherein the metadata subscription information is provided by at least one of a resource provider or a second provider, the second provider operating in at least one of a same execution environment as the resource provider of the network-accessible resource and a different execution environment.

28. The method of claim 20 wherein the metadata includes a location of a principal resource for tracking on a map.

29. The method of claim 27 wherein the network-accessible resource is a service and the location of the service is indicated on the map.

30. The method of claim 27 wherein the location is associated with a home location and an actual location.

31. A system for accessing metadata associated with a network-accessible resource, the system comprising:
means for receiving a resource message including access information for accessing a network-accessible resource;
means for receiving, with the resource message, metadata subscription information for establishing a subscription for metadata associated with the resource;
means for establishing a subscription to the metadata based on the metadata subscription information;
means for receiving the metadata associated with the resource pursuant to the subscription; and
means for presenting the metadata that is received with a representation of the network-accessible resource that is received based on the access information in the resource message.

32. A system for accessing metadata associated with a network-accessible resource, the system comprising:
a content manager component configured for receiving a resource message including access information for accessing a network-accessible resource;
a subscription manager component configured for receiving, with the resource message, metadata subscription information for establishing a subscription for metadata associated with the resource;
a subscription interface layer configured for establishing a subscription to the metadata based on the subscription information;
a metadata handler component configured for receiving the metadata associated with the resource pursuant to the subscription; and
a metadata widget handler component configured for presenting the metadata that is received with a representation of the network-accessible resource that is received based on the access information in the resource message.

33. The system of claim 29 wherein the content manager component can be configured for receiving the resource message via a browser.

34. The system of claim 29 wherein the subscription manager component can be configured for receiving the metadata subscription information in one of a header, trailer, or payload of the response.

35. The system of claim 29 wherein the subscription interface layer is configured for sending a subscribe message to a subscription service in establishing the subscription.

36. The system of claim 29 wherein the metadata widget handler component can be configured for presenting the metadata before or after the network-accessible resource is presented.

37. A system for providing access to metadata associated with a network-accessible resource, the system comprising:
means for receiving an indication for providing access to a network-accessible resource;
means for providing, responsive to receiving the indication, metadata subscription information for establishing a subscription for metadata associated with the resource; and
means for providing, responsive to receiving the indication, access to the network-accessible resource.

38. A system for providing access to metadata associated with a network-accessible resource, the system comprising:
an indication handler component configured for receiving an indication for providing access to a network-accessible resource;
a response generator component configured for providing, responsive to receiving the indication, metadata subscription information for establishing a subscription for metadata associated with the resource; and
a message interface layer component configured for providing, responsive to receiving the indication, access to the network-accessible resource.

39. The system of claim 38 wherein the message interface layer is configured to provide the subscription information by a resource provider to an application, the application in one of a same execution environment as the resource provider of the network-accessible resource or a different execution environment.

40. A computer readable medium embodying a computer program, executable by a machine, for accessing metadata associated with a network-accessible resource, the computer program comprising executable instructions for:
receiving a resource message including access information for accessing a network-accessible resource;
receiving, with the resource message, metadata subscription information for establishing a subscription for metadata associated with the resource;
establishing a subscription to the metadata based on the subscription information;
receiving the metadata associated with the resource pursuant to the subscription; and
presenting the metadata that is received with a representation of the network-accessible resource that is received based on the access information in the resource message.

41. A computer readable medium embodying a computer program, executable by a machine, for providing access to metadata associated with a network-accessible resource, the computer program comprising executable instructions for:
receiving an indication for providing access to a network-accessible resource;
providing, responsive to receiving the indication, metadata subscription information for establishing a subscription for metadata associated with the resource; and
providing, responsive to receiving the indication, access to the network-accessible resource.
